(19) United States
(12) Patent Application Publication
(10) Pub. No.: US 2009/0108916 A1
(43) Pub. Date: Apr. 30, 2009

(54) PUMP CIRCUIT

(75) Inventors: Kwang Ho Baek, Seoul (KR); Sam Kyu Won, Yongin-si (KR); Jae Won Cha, Seoul (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hynix Semiconductor Inc., Icheon-si (KR)

(21) Appl. No.: 12/117,691

(22) Filed: May 8, 2008

(30) Foreign Application Priority Data
Oct. 30, 2007 (KR) 10-2007-0109504

(51) Int. Cl. G05F 3/02

(52) U.S. Cl. 327/536

(57) ABSTRACT

A pump circuit includes a plurality of transfer elements, capacitors, and controllers. The transfer elements are connected in series between a power supply terminal and an output terminal. The capacitors charge two terminals of each of the transfer elements according to first and second clock signals, respectively. Each of the controllers includes first and second switch elements, which are operated in opposite manners in response to the first or second clock signal to control each of the transfer elements.

### CROSS-REFERENCES TO RELATED APPLICATIONS

The present application claims priority to Korean patent application number 10-2007-109504, filed on Oct. 30, 2007, which is incorporated by reference in its entirety.

### BACKGROUND OF THE INVENTION

The present invention relates to a charge pump circuit and, more particularly, to a pump circuit which can reduce its area by reducing the number of capacitors.

In recent years, there has been an increasing demand for semiconductor memory devices that can be electrically programmed and erased and that retain data when power is off. In order to develop large-capacity memory devices capable of storing a large amount of data, highly-integrated memory cells have been developed. To this end, there has been proposed a NAND flash memory device in which a plurality of memory cells are connected in series to constitute one string, and a plurality of the strings forms one memory cell array.

Flash memory cells of a NAND flash memory device include a current pass formed between source-drain on a semiconductor substrate, and a floating gate and a control gate formed between insulating layers over the semiconductor substrate. Programming of the flash memory cell is generally performed by grounding the source/drain regions of the memory cell and the semiconductor substrate (that is, a bulk region) and applying a positive program voltage (Vpp) (for example, 15 to 20 V) to the control gate to generate Fowler-Nordheim tunneling (F-N tunneling) between the floating gate and the substrate. In F-N tunneling, electrons of the bulk region are accumulated on the floating gate by an electric field of the program voltage (Vpp) applied to the control gate, thereby increasing the threshold voltage of the memory cell.

Erasing the flash memory cell is performed by applying an erase voltage (Vera, for example, −10V) to the control gate and a specific voltage (for example, 5V) to the bulk region to generate F-N tunneling so that an erase is performed for every sector sharing the bulk region. The F-N tunneling causes electrons accumulated on the floating gate to be discharged to the source region. The flash memory cells have erase threshold voltage distributions of about −2V to −3V. In cells with a threshold voltage that has been increased by the program operation, current is prevented from being injected from the drain region to the source region during a read operation, which causes the cells to appear inactive. Further, in cells with a threshold voltage that has been lowered by an erase operation, current is injected from the drain region to the source region, which causes the cells to appear active.

A bias voltage for a read or program operation of a NAND flash memory is supplied by the pump circuit described below.

FIG. 1 is circuit diagram of a conventional 4-phase charge pump.

Referring to FIG. 1, a pump circuit 100 shows a 4-phase charge pump circuit and includes a plurality of stages including first and second stages 110, 120. The first stage 110 includes first and second NMOS transistors N1, N2, and first and second capacitors C1, C2. The second stage 120 includes third and fourth NMOS transistors N3, N4 and third and fourth capacitors C3, C4. All of the stages of the pump circuit 100 are constructed identically to the first or second stage 110 or 120.

The construction of the first stage 110 is as follows.

The first capacitor C1 is connected between a fourth clock CLK4 and a node K2. The first capacitor C1 is charged or discharged in response to the fourth clock CLK4. The second capacitor C2 is connected between a node K3 and a first clock CLK1. The second capacitor C2 is charged or discharged in response to the first clock CLK1.

The first NMOS transistor N1 is connected between a node K1 and the node K2. The gate of the first NMOS transistor N1 is connected to the node K3. The second NMOS transistor N2 is connected between the node K1 and the node K3. The gate of the second NMOS transistor N2 is connected to the node K2.

The second stage 120 is constructed as follows.

The third capacitor C3 is connected between a third clock CLK3 and a node K4. The third capacitor C3 is charged or discharged in response to the third clock CLK3. The fourth capacitor C4 is connected between a node K5 and a second clock CLK2. The fourth capacitor C4 is charged or discharged in response to the second clock CLK2.

The third NMOS transistor N3 is connected between the node K3 and the node K4. The gate of the third NMOS transistor N3 is connected to the node K5. Further, the fourth NMOS transistor N4 is connected between the node K3 and the node K5. The gate of the fourth NMOS transistor N4 is connected to the node K4.

The first to fourth clocks CLK1 to CLK4 that are respectively input to the first to fourth capacitors C1 to C4 have the following phases.

FIG. 2 illustrates clock signals provided to the 4-phase charge pump of FIG. 1.

Referring to FIG. 2, the first to fourth clocks CLK1 to CLK4 that are respectively input to the first to fourth capacitors C1 to C4 of FIG. 1 have different phases.

In FIG. 1, the first and third capacitors C1, C3 function as boosting capacitors, the second and fourth NMOS transistors N2, N4 perform a transfer function, and the third and fourth capacitors C3, C4 function as stage capacitors.

When the first and second clocks CLK1, CLK2 are at a high level, the second and fourth capacitors C2, C4 are charged. When the third and fourth clocks CLK3, CLK4 are at a high level, the first and third capacitors C1, C3 are charged. If the first and third capacitors C1, C3 are charged, a high-level voltage is input to the gates of the second and fourth NMOS transistors N2, N4, which are then activated. While the second and fourth NMOS transistors N2, N4 are activated, charges of the second and fourth capacitors C2, C4 are transferred to a next stage.

Thus, in order to transfer charges to a next stage, one or more boosting capacitors, such as the first and third capacitors C1, C3, are necessary for each stage. Requiring one or more boosting capacitors in each stage is not conducive to reducing the size of a pump because the capacitors occupy a large portion of the pump relative to the size of a pump circuit.

### BRIEF SUMMARY OF THE INVENTION

The present invention is directed towards a pump circuit which can reduce a circuit area by reducing the number of capacitors of the pump circuit.

A pump circuit according to an aspect of the present invention includes a plurality of transfer elements, capacitors, and controllers. The transfer elements are connected in series between a power supply terminal and an output terminal. The capacitors charge two terminals of each of the transfer elements according to first and second clock signals, respectively. Each of the controllers includes first and second switch elements, which are operated in opposite manners in response to the first or second clock signal to control each of the transfer elements.

The transfer element is a transistor that is turned on or off according to operations of the first and second switch elements.

The first switch element of each of the controllers activates the transfer element in response to any one of the first and second clock signals and transfers a voltage, which is boosted by a capacitor of a previous stage, to a capacitor of a next stage. While the transfer element of each of the controllers is turned on, a second switch element of a previous stage turns off the transfer element of the previous stage in response to any one of the first and second clock signals.

The first or second switch element is turned on or off in response to the first clock signal and supplies the second clock signal to control the operation of the transfer element.

The first switch element and the second switch element include transistors respectively having opposite operating characteristics.

A pump circuit according to another aspect of the present invention includes a plurality of transfer elements, voltage storage means, and operation control means. The transfer elements are connected in series between a power supply terminal and an output terminal. The voltage storage means uses a voltage, which is transferred from a previous stage by the transfer element operating according to a first clock signal, as a start voltage. The voltage storage means increases the start voltage to a first voltage in response to a second clock signal. The operation control means controls the transfer elements in response to the first clock signal.

The voltage storage means includes a capacitor.

Two capacitors connected to the voltage storage means are respectively connected to both terminals of the transfer element and are charged by the first or second clock signal.

The operation control means includes a first switch element and a second switch element. The first switch element turns on the transfer element in response to any one of the first and second clock signals and transfers a voltage, which is boosted in a capacitor of a previous stage, to a capacitor of a next stage. The second switch element turns off a transfer element of a previous stage in response to any one of the first and second clock signals while the transfer element is turned on.

The first or second switch element is turned on or off in response to the first clock signal and supplies the second clock signal to control the operation of the transfer element.

The first switch element and the second switch element include transistors respectively having opposite operating characteristics.

### BRIEF DESCRIPTION OF THE DRAWINGS

FIG. 1 is circuit diagram of a conventional 4-phase charge pump;

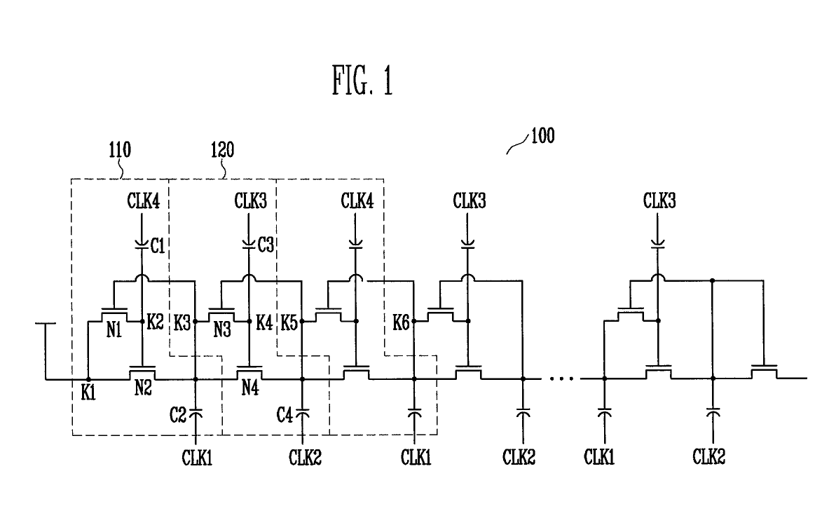

FIG. 2 illustrates clock signals provided to the 4-phase charge pump of FIG. 1;

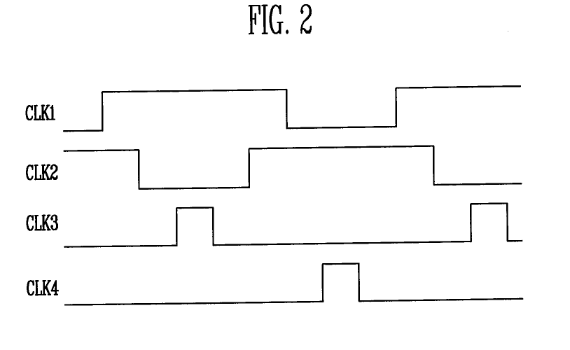

FIG. 3 is a partial circuit diagram of a pump circuit in accordance with an embodiment of the present invention; and

FIG. 4 is a timing diagram of the pump circuit of FIG. 3.

### DESCRIPTION OF SPECIFIC EMBODIMENTS

A specific embodiment according to the present invention will be described with reference to the accompanying drawings. The present invention is not limited to the disclosed embodiment, but may be implemented in various manners. The embodiment is provided to complete the disclosure of the present invention and to allow those having ordinary skill in the art to understand the present invention. The present invention is defined by the scope of the claims.

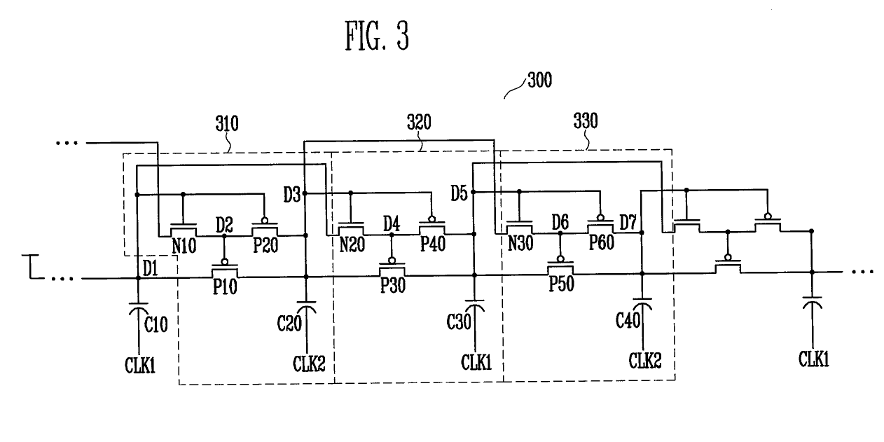

FIG. 3 is a partial circuit diagram of a pump circuit in accordance with an embodiment of the present invention.

Referring to FIG. 3, a pump circuit 300 in accordance with an embodiment of the present invention includes a plurality of pump stages including first to third stages 310 to 330. Each stage pumps charges, which are transferred from a previous stage, and transfers the pumped charges to a next stage. Thus, a high pumping output voltage is generated.

The first stage 310 includes a first NMOS transistor N10, first and second PMOS transistors P10, P20 and a second capacitor C20. The second stage 320 includes a second NMOS transistor N20, third and fourth PMOS transistors P30, and P40 and a third capacitor C30. The third stage 330 includes a third NMOS transistor N30, fifth and sixth PMOS transistors P50, P60 and a fourth capacitor C40. A previous stage of the first stage 310 includes a first capacitor C10.

The first capacitor C10 is connected between a first node D1 and an input terminal of a first clock CLK1.

The first NMOS transistor N10 of the first stage 310 is connected between a connection node of a clock and a capacitor of the previous stage, and a second node D2. The gate of the first NMOS transistor N10 is connected to the first node D1.

The first PMOS transistor P10 is connected between the first node D1 and a third node D3. The gate of the first PMOS transistor P10 is connected to the second node D2. The second PMOS transistor P20 is connected between the second node D2 and the third node D3. The gate of the second PMOS transistor P20 is connected to the first node D1. The second capacitor C20 is connected between the third node D3 and an input node of a second clock CLK2.

In the first stage 310, the first PMOS transistor P10 transfers charges of the first capacitor C10 (that is, a capacitor of a previous stage) to the second capacitor C20 (that is, a capacitor of a next stage). The first NMOS transistor N10 and the second PMOS transistor P20 control the first PMOS transistor P10. Further, the second capacitor C20 provides a voltage in response to an input clock.

The second NMOS transistor N20 is connected between the first node D1 and a fourth node D4. The fourth PMOS transistor P40 is connected between the fourth node D4 and a fifth node D5. The gates of the second NMOS transistor N20 and the fourth PMOS transistor P40 are commonly connected to the third node D3.

The third PMOS transistor P30 is connected between the third node D3 and the fifth node D5. The gate of the third PMOS transistor P30 is connected to the third node D3. The third capacitor C30 is connected between the fifth node D5 and an input node of the first clock CLK1.

In the second stage 320, the third PMOS transistor P30 transfers charges of the second capacitor C20 to the third capacitor C30. The second NMOS transistor N20 and the fourth PMOS transistor P40 control the third PMOS transistor P30. The third capacitor C30 provides a voltage in response to an input clock.

The third NMOS transistor N30 is connected between the fifth node D3 and a sixth node D6. The sixth PMOS transistor P60 is connected between the sixth node D6 and a seventh node D7. The gates of the third NMOS transistor N30 and the sixth PMOS transistor P60 are commonly connected to the fifth node D5.

The fifth PMOS transistor P50 is connected between the fifth node D5 and the seventh node D7. The gate of the fifth PMOS transistor P50 is connected to the sixth node D6. The fourth capacitor C40 is connected between the seventh node D7 and an input node of the second clock CLK2.

In the third stage 330, the fifth PMOS transistor P50 transfers charges of the third capacitor C30 to the fourth capacitor C40. The third NMOS transistor N30 and the sixth PMOS transistor P60 control the fifth PMOS transistor P50. The fourth capacitor C40 provides a voltage in response to an input clock.

The first to third stages 310 to 330 illustrate only a part of the pump circuit 300 according to an embodiment of the present invention. The same circuit can be constructed of a plurality of stages and pump a program voltage.

An operation of the pump circuit 300 is described as follows.

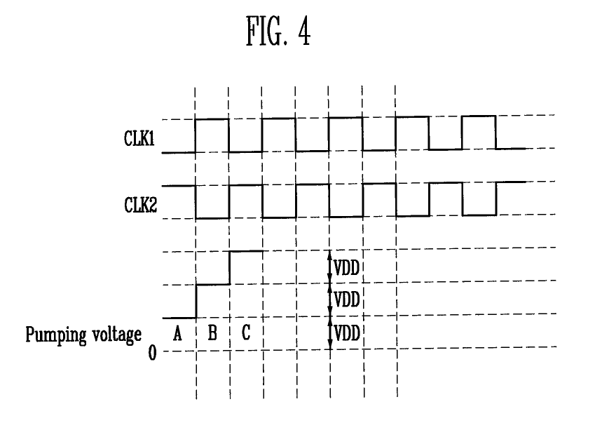

FIG. 4 is a timing diagram of the pump circuit of FIG. 3.

Referring to FIG. 4, the first and second clocks CLK1, CLK2 that are input to the pump circuit 300 are clock signals having opposite phases. The first and second clocks CLK1, CLK2 supply voltages VDD at a high level.

A process in which the pumping voltage is increased by the pumping of the pump circuit 300 is divided into three processes, which are shown as three sections A to C. The operation of the pump circuit 300 in each section can be described with reference to the following table.

TABLE

| | A | B | C |
|---|---|---|---|
| CLK1 | L | H | L |
| CLK2 | H | L | H |
| C10 | Discharge (L) | | |
| N10 | OFF | | |
| P10 | OFF | | |
| P20 | ON | | |
| C20 | Charge (VDD) | | |
| N20 | ON | OFF | |
| P30 | ON | OFF | |
| P40 | OFF | ON | |
| C30 | Charge (VDD): | Charge | |
| | transfer from | (VDD + VDD) | |
| | C20 | | |
| N30 | | ON | OFF |
| P50 | | ON | OFF |
| P60 | | OFF | ON |
| C30 | | Charge (2VDD): | Charge |
| | | transfer from | (2VDD + VDD) |
| | | C30 | |

The operation of the pump circuit 300 is described in detail below with reference to FIG. 4 and the table.

In section A, the first clock CLK1 is at a low level and the second clock CLK2 is at a high (VDD) level. The first node D1 becomes a low level by the first clock CLK1 and the third node D3 becomes a high level (that is, VDD) by the second clock CLK2.

Thus, the first NMOS transistor N10 is turned off and the second PMOS transistor P20 is turned on. When the second PMOS transistor P20 is turned on, the third node D3 and the second node D2 are connected such that the second node D2 becomes a high level and the first PMOS transistor P10 is turned off.

The second capacitor C20 is charged by the input voltage VDD that is input by the second clock CLK2. It is assumed that in a state where there is no voltage transferred from the first capacitor C10, the second capacitor C20 has been charged with the input voltage VDD from a voltage level of 0V by the second clock CLK2.

The second NMOS transistor N20 is turned on and the fourth PMOS transistor P40 is turned off in response to the second clock CLK2. When the second NMOS transistor N20 is turned on, the first node D1 and the fourth node D4 are connected, and the third PMOS transistor P30 is turned on.

Thus, the input voltage VDD charged to the second capacitor C20 is transferred to the fifth node D5, and the third capacitor C30 is charged to the input voltage VDD.

Thereafter, in section B, the first clock CLK1 becomes a high level and the second clock CLK2 becomes a low level. Thus, the third node D3 becomes a low level and the fifth node D5 becomes a high level.

The third capacitor C30 is further charged to the input voltage VDD by the first clock CLK1 in addition to the input voltage VDD, which has been transferred from the second capacitor C20 in section A. Thus, the third capacitor C30 is charged to 2VDD.

The second NMOS transistor N20 is turned off and the fourth PMOS transistor P40 is turned on. When the fourth PMOS transistor P40 is turned on, the fourth node D4 is connected to the fifth node D5, and the third PMOS transistor P30 is turned off.

Since the fifth node D5 is at a high level, the third NMOS transistor N30 is turned on and the sixth PMOS transistor P60 is turned off. When the third NMOS transistor N30 is turned on, the third node D3 and the sixth node D7 are connected, and the fifth PMOS transistor P50 is turned on.

When the fifth PMOS transistor P50 is turned on, the fifth node D5 and the seventh node D7 are connected. Thus, the voltage 2VDD charged to the third capacitor C30 is transferred to the fourth capacitor C40, and the fourth capacitor C40 is charged to 2VDD.

Thereafter, in section C, the first clock CLK1 becomes a low level and the second clock CLK2 becomes a high level. The third NMOS transistor N30 is turned off, the sixth PMOS transistor P60 is turned on, and the fifth PMOS transistor P50 is turned off.

The fourth capacitor C40 charged to 2VDD in section B is increased by input voltage VDD of the second clock CLK2 and is therefore charged to a total voltage of 3VDD.

As described above, when the operations of sections A to C are performed, a higher pumping voltage is generated after each stage. The above description is given without considering voltage loss due to the properties of each element.

In the pump circuit 300 described above, a boosting capacitor for controlling charge transfer is not required. Thus, an area occupied by capacitors in the pump circuit can be reduced and, therefore, the entire area of the pump circuit can be reduced.

As described above, the pump circuit according to the present invention minimizes the area of a transfer unit for transferring charges. Accordingly, the entire area of the pump circuit can be minimized.

The embodiments disclosed herein have been proposed to allow a person skilled in the art to easily implement the present invention, and the person skilled in the part may implement the present invention by a combination of several embodiments. Therefore, the scope of the present invention is not limited by or to the embodiments as described above, and should be construed to be defined only by the appended claims and their equivalents.

What is claimed is:

1. A pump circuit comprising:
a plurality of transfer elements connected in series between a power supply terminal and an output terminal, wherein each transfer element comprises a first terminal and a second terminal, each transfer element corresponding to a different stage in the pump circuit;
a plurality of capacitors, wherein a first capacitor is connected to the first terminal of each transfer element and a second capacitor is connected to the second terminal of each transfer element, the capacitors being configured to increase the voltage at the first terminal and the second terminal according to a first clock signal and a second clock signal, respectively; and
a plurality of controllers, wherein each controller comprises a first switch element and a second switch element, wherein the first switch element and the second switch element are operated in oppositely in response to the first clock signal or the second clock signal to control the corresponding transfer element.

2. The pump circuit of claim 1, wherein each transfer element comprises a transistor that is turned on or off according to the first switch element and the second switch element.

3. The pump circuit of claim 1, wherein:
the first switch element of each controller turns on the corresponding transfer element in response to one of the first clock signal and the second clock signal,
the first switch element of each controller transfers a voltage to the first capacitor of a next stage, the transferred voltage being increased by the second capacitor of a previous stage, and
in the event that the transfer element of each controller is turned on, the second switch element of a previous stage turns off the transfer element of the previous stage in response to one of the first clock signal and the second clock signal.

4. The pump circuit of claim 1, wherein:
the first switch element or the second switch element is turned on or off in response to the first clock signal, and
the first switch element or the second switch element supplies the second clock signal to control the operation of the corresponding transfer element.

5. The pump circuit of claim 1, wherein the first switch element comprises a first transistor and the second switch element comprises a second transistor, the first transistor and the second transistor having opposite operating characteristics.

6. A pump circuit comprising:
a plurality of transfer elements connected in series between a power supply terminal and an output terminal, wherein each transfer element comprises a first terminal and a second terminal, each transfer element corresponding to a different stage in the pump circuit;
voltage storage means configured to us a voltage transferred from a previous stage by the corresponding transfer element operating according to a first clock signal, wherein the voltage storage means increases the start voltage to a first voltage in response to a second clock signal; and
operation control means for controlling an operation of the corresponding transfer element in response to the first clock signal.

7. The pump circuit of claim 6, wherein the voltage storage means comprises a capacitor.

8. The pump circuit of claim 6, wherein the voltage storage means comprises a first capacitor and a second capacitor capacitors, the first capacitor being connected to a first terminal of the corresponding transfer element the second capacitor being connected to a second terminal of the corresponding transfer element, the first capacitor and the second capacitor being charged by the first clock signal or second clock signal.

9. The pump circuit of claim 8, wherein the operation control means comprises:
a first switch element that is configured to activate the corresponding transfer element in response to one of the first clock signal and the second clock signal, wherein the first switch element transfers a voltage to the first capacitor of a next stage, the transferred voltage being increased by the second capacitor of a previous stage, and
in the event that the corresponding transfer element is turned on, a second switch element that turns off the transfer element of the previous stage in response to one of the first clock signal and the second clock signal.

10. The pump circuit of claim 9, wherein the first switch element or the second switch element is turned on or off in response to the first clock signal, the first switch element or second switch element supplying the second clock signal to control the operation of the corresponding transfer element.

11. The pump circuit of claim 9, wherein the first switch element comprises a first transistor and the second switch element comprises a second transistor, the first transistor and the second transistor having opposite operating characteristics.
